(19) United States
(12) Patent Application Publication
(10) Pub. No.: US 2024/0378857 A1
(43) Pub. Date: Nov. 14, 2024

(54) DRONE DETECTION METHOD AND SYSTEM BASED ON INFRARED POLARIZATION

(71) Applicant: Hefei Polytechnic University, Anhui (CN)

(72) Inventors: Zhiguo FAN, Hefei (CN); Minrui YE, Hefei (CN); Rui QIAO, Hefei (CN); Yiwei WU, Hefei (CN); Li CHEN, Hefei (CN); Quan HU, Hefei (CN); Ziyi ZOU, Hefei (CN)

(21) Appl. No.: 18/286,428

(22) PCT Filed: Jul. 11, 2022
(86) PCT No.: PCT/CN2022/104786

§ 371 Date: Oct. 11, 2023

(30) Foreign Application Priority Data
Jul. 16, 2021 (CN) 202110807137.8

(51) Int. Cl. G06V 10/762; G06V 20/52

(52) U.S. Cl. CPC G06V 10/762; G06V 20/52; G06V 2201/07; G06V 2201/08

(57) ABSTRACT

A drone detection method and system based on infrared polarization is disclosed. By utilizing the significant difference in polarization characteristics between drone targets and background, the infrared polarization image in the polarization direction orthogonal to the background polarization angle and the infrared light intensity image after an adaptive contrast entropy top-hat transformation are fused to suppress the background and improve the contrast between the targets and background. Finally, the fused image is subjected to intuitionistic fuzzy C-means clustering induced by polarization information probability to detect drone targets in complex backgrounds. The present disclosure can improve the accuracy of drone detection.

### TECHNICAL FIELD

The present disclosure relates to the technical field of imaging detection, and more specifically, to a drone detection method and system based on infrared polarization.

BACKGROUND ART

The current existence of drone misuse brings great security risks to the low altitude range, and the problem of detecting illegal intrusion of drone targets becomes an important research direction in the low altitude defense system.

The existing technology carries out drone detection through photoelectric detection technology. Among them, there are two main categories of traditional photoelectric detection techniques: visible light imaging and infrared imaging.

Visible light imaging uses a visible light camera to detect the video image of the target drone, so as to recognize and confirm the target, and track the target. This technology is suitable for use during the daytime, and its equipment cost is low and its application is more common.

Infrared imaging utilizes infrared cameras to detect the infrared image of the target drone and thus identify and track the drone. In fact, all objects with temperatures above absolute zero are radiating infrared rays, and the heat generated by the battery and motor during the flight of the drone will provide an opportunity for the application of infrared detection and identification technology.

The traditional infrared imaging detection system mainly acquires the infrared thermal radiation of the observed scene, and uses the difference in radiation intensity between the target and the background to distinguish the target from the background, and then realizes the detection, identification and tracking of the target. Infrared detection technology has good concealment, long imaging distance, and can eliminate atmospheric interference to a certain extent. It has strong environmental adaptability for observing targets under obscuration, and is a powerful investigative tool in modern warfare. However, with the development of new infrared camouflage coatings and related infrared stealth design technology, the thermal radiation characteristics of the target surface has been greatly weakened, reducing the difference between the target and the background of the thermal radiation; at the same time, decoys, sea clutter, and other factors greatly weaken the infrared radiation difference between the target and the background, making it difficult to effectively detect the target using traditional infrared detection methods. Infrared images belong to the temperature difference imaging, with the characteristics of “high background, low temperature difference”. For example, the ground scene or low altitude scene temperature is usually about 300K (27° C.), while the ground people or low altitude drone and the scene temperature difference is only a few tens of degrees Celsius, so the contrast of the infrared image is very low and lack of silhouette details. When the radiation in the scene reaches the detector through atmospheric transmission, it will be affected by the atmospheric transmission conditions, which will reduce the amount of infrared radiation that the detector can receive, resulting in weaker target intensity and lower signal-to-noise ratio in the image. At the same time, the high-temperature targets in the scene will radiate heat to the surrounding scene, making the target boundary details in the infrared image blurred.

Moreover, “low, slow and small” drone targets are typically dim small targets when they are far away from the infrared imaging detection system. The drone has a very low Signal-to-Clutter Ratio (SCR) between the target and the background due to the low infrared radiation and the small temperature difference with the surrounding background. In an image containing a dim small target, the target point of greatest interest occupies a very small portion of a single frame, containing only grayscale information and lacking critical information such as texture details. The background, which occupies a large area in the image, is rich in texture details and has a large range of grayscale distribution, which will cause some interference in target detection. The detection algorithm for dim small targets has its own specificity compared with the area target detection algorithm, in which the suppression of the complex background of the image is a key step in the detection of dim small targets.

General infrared small target detection methods use clustering algorithms to cluster infrared images, which have poor detection effects, and the target contour of the drone is incomplete or the target cannot be detected.

Therefore, a new detection method or system is urgently needed to solve the above problems and thus improve the accuracy of drone detection.

SUMMARY

The object of the present disclosure is to provide a drone detection method and system based on infrared polarization, which can improve the accuracy of drone detection.

In order to achieve the above purpose, technical solutions of the present disclosure are specifically described as follows:

A drone detection method based on infrared polarization includes the following steps:
acquiring polarization images at three different polarization angles in a target scene;
calculating a Stokes vector based on the polarization images at three different polarization angles; wherein the Stokes vector comprises: a light intensity image, a difference between a horizontal linear polarization component and a vertical linear polarization component, and a difference between a 45° linear polarization component and a 135° linear polarization component;
normalizing a linear polarization degree image and a polarization angle image determined according to the Stokes vector separately, and then superimposing the normalized linear polarization degree image and the normalized polarization angle image to determine a three-dimensional image;
performing coarse clustering on the three-dimensional image using a K-means clustering method to classify pixel points of the three-dimensional image into target class pixel points and background class pixel points; and calculating a mean value and a covariance matrix of the target class pixel points and a mean value and a covariance matrix of the background class pixel points, respectively;
initializing a Gaussian mixed model according to the mean value and covariance matrix of the target class pixel points and the mean value and covariance matrix of the background class pixel points, and then performing secondary clustering on the three-dimensional image, and determining a mean value and a covariance matrix of the target class pixel points and a mean value and a covariance matrix of the background class pixel points after the secondary clustering;
constructing a two-dimensional Gaussian probability model based on the mean value and covariance matrix of the target class pixel points after the secondary clustering, and determining a target probability image;
determining a polarization direction orthogonal to a background polarization angle based on the mean value of the polarization angle image in the background class pixel points after the secondary clustering; and thereby determining a target linear polarization component image under the polarization direction orthogonal to the background polarization angle;
performing an adaptive contrast entropy top-hat transformation on the light intensity image to determine an output image;
performing a Laplace pyramid fusion on the output image with the target linear polarization component image to determine a fused image;
determining a binarized image by weighting a membership matrix using the target probability image and clustering the fused image using an intuitionistic fuzzy C-mean clustering algorithm induced by polarization information; and
determining a target based on the binarized image; wherein the target is a drone.

Optionally, the step of calculating a Stokes vector based on the polarization images at three different polarization angles specifically includes:
determining the light intensity image using the formula [symbol] ;
determining the difference between the horizontal linear polarization component and the vertical linear polarization component using the formula [symbol] ;
determining the difference between the 45° linear polarization component and the 135° linear polarization component using the formula [symbol] ;
wherein, [symbol] is the light intensity image, [symbol] is the difference between the horizontal linear polarization component and the vertical linear polarization component, [symbol] is the difference between the 45° linear polarization component and the 135° linear polarization component, and represents a polarization image when a polarizer is rotated at an angle of [symbol] .

Optionally, the step of determining a polarization direction orthogonal to a background polarization angle based on the mean value of the polarization angle image in the background class pixel points after the secondary clustering; and thereby determining a target linear polarization component image under the polarization direction orthogonal to the background polarization angle specifically includes:
determining a background polarization angle by back-normalizing the mean value of the polarization angle image in the background class pixel points after secondary clustering using the formula [symbol] ;
determining a polarization direction orthogonal to the background polarization angle based on the background polarization angle;
determining a polarization component in a direction orthogonal to the background polarization angle using the formula [symbol] ;
determining a target linear polarization component image in the polarization direction orthogonal to the background polarization angle using the formula [symbol] ;
wherein [symbol] is the background polarization angle, is the polarization component in the direction orthogonal to the background polarization angle, is the non-polarization light component in [symbol] , is the target linear polarization component image in the polarization direction orthogonal to the background polarization angle, and is the mean value of the polarization angle image in the background class pixels after secondary clustering.

Optionally, the step of performing an adaptive contrast entropy top-hat transformation on the light intensity image to determine an output image, specifically includes:
applying a weighted local adaptive structural element to the light intensity image and performing an erosion operation;
applying an adaptive structural element to the light intensity image after the erosion operation and performing an expansion operation; and
subtracting the light intensity image after the expansion operation from the light intensity image, and determining the output image after the adaptive contrast entropy top-hat transformation.

A drone detection system based on infrared polarization includes the following modules:
a polarization image acquisition module for acquiring polarization images at three different polarization angles in a target scene;
a Stokes vector calculation module for calculating a Stokes vector based on the polarization images at three different polarization angles; wherein the Stokes vector comprises:
a light intensity image, a difference between a horizontal linear polarization component and a vertical linear polarization component, and a difference between a 45° linear polarization component and a 135° linear polarization component;
a three-dimensional image determination module for determining a three-dimensional image by normalizing a linear polarization degree image and a polarization angle image determined according to the Stokes vector separately, and then superimposing the normalized linear polarization degree image and the normalized polarization angle image;
a first clustering module for performing coarse clustering on the three-dimensional image using a K-means clustering method to classify pixel points of the three-dimensional image into target class pixel points and background class pixel points; and calculating a mean value and a covariance matrix of the target class pixel points and a mean value and a covariance matrix of the background class pixel points, respectively;
a second clustering module for initializing a Gaussian mixture model according to the mean value and covariance matrix of the target class pixel points and the mean value and covariance matrix of the background class pixel points, and then performing secondary clustering on the three-dimensional image, and determining a mean value and a covariance matrix of the target class pixel points and a mean value and a covariance matrix of the background class pixel points after secondary clustering;
a target probability image determination module for constructing a two-dimensional Gaussian probability model based on the mean value and covariance matrix of the target class pixel points after the secondary clustering, and determining a target probability image;
a target linear polarization component image determination module for determining a polarization direction orthogonal to a background polarization angle based on the mean value of the polarization angle image in the background class pixel points after the secondary clustering; and thereby determining a target linear polarization component image under a polarization direction orthogonal to the background polarization angle;
an output image determination module for performing an adaptive contrast entropy top-hat transformation on the light intensity image to determine an output image;
a fused image determination module for performing a Laplace pyramid fusion on the output image with the target linear polarization component image to determine a fused image;
a binarized image determination module for determining a binarized image by weighting a membership matrix using the target probability image and clustering the fused image using an intuitionistic fuzzy C-mean clustering algorithm induced by polarization information; and
a target determination module for determining a target based on the binarized image; wherein the target is a drone.

Optionally, the Stokes vector calculation module specifically includes:
a light intensity image determination unit for determining the light intensity image using the formula [symbol] ;
a difference between horizontal linear polarization component and vertical linear polarization component determination unit for determining the difference between the horizontal linear polarization component and the vertical linear polarization component using the formula [symbol] ;
a difference between 45° linear polarization component and 135° linear polarization component determination unit for determining the difference between the 45° linear polarization component and the 135° linear polarization component using the formula [symbol] ;
wherein, [symbol] is the light intensity image, [symbol] is the difference between the horizontal linear polarization component and the vertical linear polarization component, [symbol] is the difference between the 45° linear polarization component and the 135° linear polarization component, and represents a polarization image when the polarizer is rotated at an angle of [symbol] .

Optionally, the target linear polarization component image determination module specifically includes:
a background polarization angle determination unit for determining a background polarization angle by back-normalizing the mean value of the polarization angle image in the background class pixel points after secondary clustering using the formula [symbol] ;
a polarization direction orthogonal to the background polarization angle determination unit for determining a polarization direction orthogonal to the background polarization angle based on the background polarization angle;
a polarization component determination unit for determining a polarization component in a direction orthogonal to the background polarization angle using the formula [symbol] ;
a target linear polarization component image determination unit for determining a target linear polarization component image in the polarization direction orthogonal to the background polarization angle using the formula [symbol] ;
wherein [symbol] is the background polarization angle, is the polarization component in the direction orthogonal to the background polarization angle, is the non-polarization light component in [symbol] , is the target linear polarization component image in the polarization direction orthogonal to the background polarization angle, and [symbol] is the mean value of the polarization angle image in the background class pixels after secondary clustering.

Optionally, the output image determination module specifically includes:
an erosion operation unit for applying a weighted local adaptive structural element to the light intensity image and performing an erosion operation;
an expansion operation unit for applying an adaptive structural element to the light intensity image after the erosion operation and performing an expansion operation; and
an output image determination unit for subtracting the light intensity image after the expansion operation from the light intensity image, and determining the output image after the adaptive contrast entropy top-hat transformation.

According to the specific embodiments provided by the present invention, the following technical effects are disclosed:

The present disclosure provides a drone detection method and system based on infrared polarization. By utilizing the significant difference in polarization characteristics between drone targets and background, the infrared polarization image in the polarization direction orthogonal to the background polarization angle and the infrared light intensity image after an adaptive contrast entropy top-hat transformation are fused to suppress the background and improve the contrast between the targets and background. Finally, the fused image is subjected to intuitionistic fuzzy C-means clustering induced by polarization information probability. It can increase the information content of drone targets while reducing the interference of sky backgrounds with weak infrared polarization characteristics, and detect drone targets in complex backgrounds. The present disclosure uses polarization information to induce the clustering process and cluster the fused images that suppress the background, which improves the clustering effect. The detected drone targets are more accurate and have more detailed contours. The present disclosure can improve the accuracy of drone detection.

### BRIEF DESCRIPTION OF THE DRAWINGS

In order to explain the embodiments of the present disclosure or the technical solutions in the prior art more clearly, the following drawings that need to be used in the description of the embodiments or the prior art are briefly introduced. Obviously, the drawings in the following description are only embodiments of the present disclosure. For those of ordinary skill in the art, other drawings can be obtained based on the drawings disclosed without creative work.

FIG. 1 shows a flow diagram of a drone detection method based on infrared polarization provided by the present disclosure;

FIG. 2 shows a schematic diagram of the overall flow of a drone detection method based on infrared polarization provided by the present disclosure;

FIG. 3 shows a flowchart for determining the target linear polarization component image in a polarization direction orthogonal to the background polarization angle;

FIG. 4 shows a schematic diagram of the adaptive contrast entropy top-hat transformation;

FIG. 5A shows a comparison image after using the present disclosure;

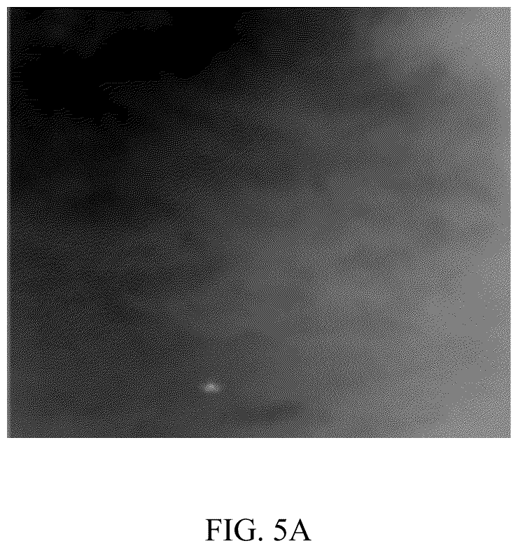

FIG. 5B shows a comparison image after using the present disclosure;

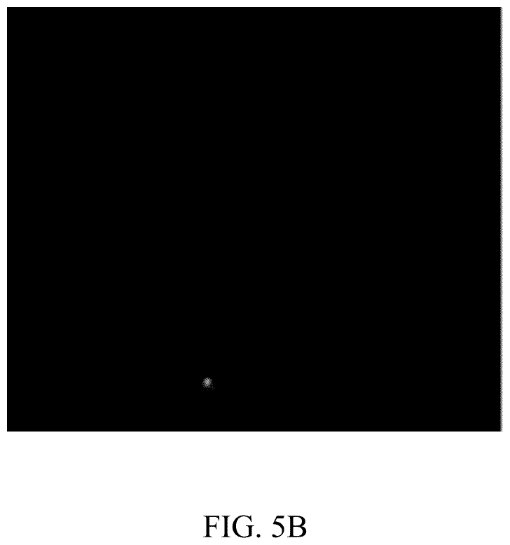

FIG. 6 shows a schematic diagram of the parameter structure of the adaptive contrast entropy top-hat transformation;

FIG. 7 shows a schematic diagram of the structure of a drone detection system based on infrared polarization provided by the present disclosure.

### DETAILED DESCRIPTION OF THE EMBODIMENTS

Technical solutions of the present disclosure will be clearly and completely described below with reference to the accompanying drawings in the embodiments of the present disclosure. Obviously, the described embodiments are only part of the embodiments of the present disclosure, not all of them. Based on the embodiments of the disclosure, all other embodiments made by those skilled in the art without sparing any creative effort should fall within the protection scope of the disclosure.

The object of the present disclosure is to provide a drone detection method and system based on infrared polarization, which can improve the accuracy of drone detection.

In order to make the above objects, features and advantages of the present disclosure more obvious and understandable, the present disclosure is described in further detail below in conjunction with the accompanying drawings and specific embodiments.

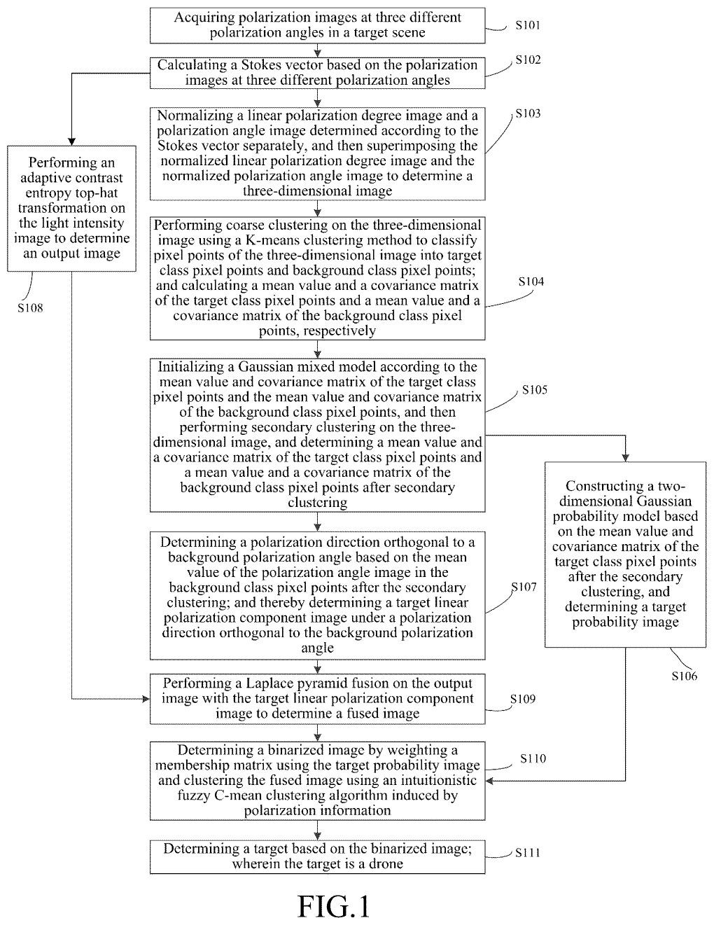

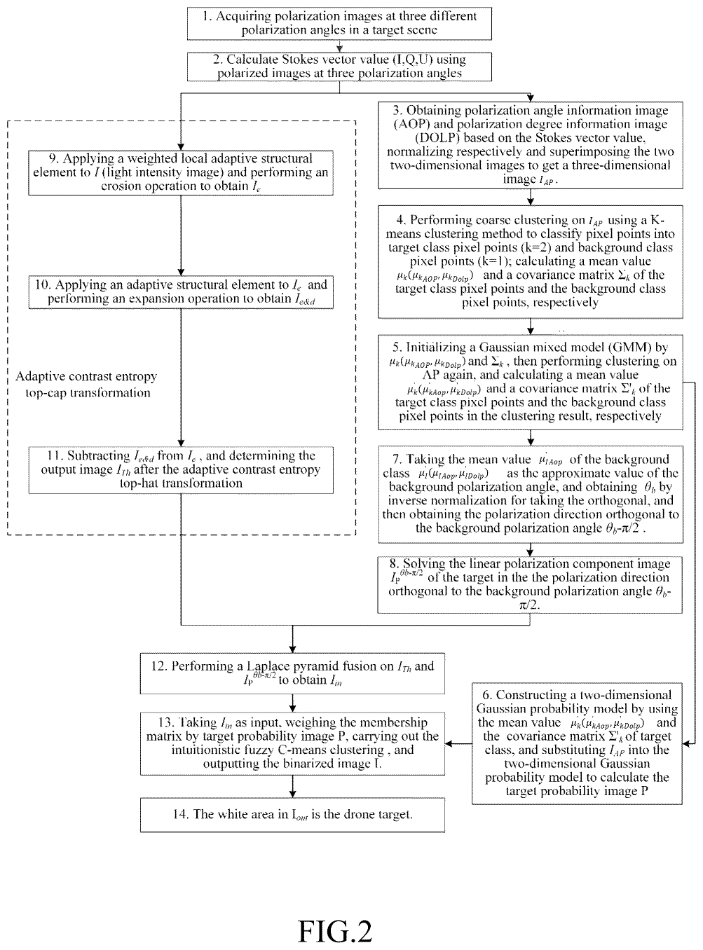

FIG. 1 shows a flow diagram of a drone detection method based on infrared polarization provided by the present disclosure, and FIG. 2 shows a schematic diagram of the overall flow of a drone detection method based on infrared polarization provided by the present disclosure. As shown in FIG. 1 and FIG. 2, a drone detection method based on infrared polarization provided by the present disclosure includes:
S101, acquiring polarization images at three different polarization angles in a target scene;
wherein, a time-rotating polarizer-type infrared polarization imaging device is adopted to obtain polarization images at three different polarization angles in the target scene; the device adopts a time-sequential work mode, which uses a stepping motor to rotate the polarizer at high speed, and when the polarizer is rotated to the specified angle, synchronous exposure of the infrared camera is completed, and the infrared camera acquires a frame of an infrared intensity image in the event of each rotation of the polarizer to the specified angle.
S102, calculating a Stokes vector based on the polarization images at three different polarization angles; wherein the Stokes vector includes: a light intensity image, a difference between a horizontal linear polarization component and a vertical linear polarization component, and a difference between a 45° linear polarization component and a 135° linear polarization component; the Mueller matrix of the linear polarizer is adopted to obtain the relationship between the intensity of the outgoing radiation and the Stokes vector of the incident light in any polarization direction. That is [symbol] .

S102 specifically includes:
determining the light intensity image using the formula [symbol] ;
determining the difference between the horizontal linear polarization component and the vertical linear polarization component using the formula [symbol] ;
determining the difference between the 45° linear polarization component and the 135° linear polarization component using the formula [symbol] ;

Linear polarization degree is the most essential feature of infrared polarization detection, reflecting the degree of polarization of polarized light, taking the value range of 0-1. The existence and difference of linear polarization degree determines the feasibility of infrared polarization detection. The physical meaning of the polarization angle is the angle between the vibration direction of the light wave and the reference direction, reflecting the polarization direction of the polarized light. Generally speaking, the polarization angle parameter of light waves from an object is an intrinsic information directly related to the apparent and intrinsic properties of the object, which can be used to characterize the state properties of the target and the background. The acquisition of linear polarization degree and polarization angle can be calculated by the combination of Stokes parameters.

The linear polarization degree image is determined using formula [symbol] ;
the polarization angle image is determined using formula [symbol] ;
wherein, [symbol] is the light intensity image, [symbol] is the difference between the horizontal linear polarization component and the vertical linear polarization component, [symbol] is the difference between the 45° linear polarization component and the 135° linear polarization component, and represents a polarization image when a polarizer is rotated at an angle of [symbol] .

There are large differences in both the linear polarization degree and polarization angle of the drone target and the background, so these two polarization characteristics can be used to differentiate between the drone target and the background.

S103, normalizing a linear polarization degree image and a polarization angle image determined according to the Stokes vector separately, and then superimposing the normalized linear polarization degree image and the normalized polarization angle image to determine a three-dimensional image; that is, each pixel point on the superimposed image is a sample, and each sample data is a two-dimensional vector consisting of the linear polarization degree and polarization angle of that pixel point.

The calculated linear polarization degree takes the value range [symbol] , and no normalization is needed; the calculated polarization angle takes the value range [symbol] , so the normalization operation for the polarization angle is:

[symbol]

The normalized DOLP image and the AOP image are superimposed into a three-dimensional image [symbol] .

S104, performing coarse clustering on the three-dimensional image using a K-means clustering method to classify pixel points of the three-dimensional image into target class pixel points and background class pixel points; and calculating a mean value and a covariance matrix of the target class pixel points and a mean value and a covariance matrix of the background class pixel points, respectively;

In order to distinguish the target from the background using the polarization property, clustering is performed using the K-mean clustering method. The samples represented by the pixel points on the image are first divided into K subsets, and K samples are randomly generated or selected as clustering centers (there are two classes, the target and background classes, so K takes the value of 2, with k=2 for the target class and k=1 for the background class).

The center of the k-th class is defined as [symbol] , and [symbol] is a two-dimensional feature vector. We need to find the class to which each sample belongs and a set of vectors, such that the sum of the squares of the distances of each sample from the center [symbol] of the class to which it belongs is minimized. To measure the similarity between the samples, the square of the Euclidean distance is adopted as the criterion:

[symbol]

Wherein, [symbol] is the i-th sample point, and [symbol] and [symbol] represent the polarization angle and linear polarization degree of the sample, respectively. The sum of the squares of the distances between all samples and the center of the class to which they belong is defined as the loss function:

[symbol]

Wherein, [symbol] is the number of pixel points of the image, if [symbol] , then it means that the sample belongs to the k-th class.

By keeping [symbol] fixed and [symbol] choosing to minimize [symbol] , that is, by assigning the sample to the class to which its nearest center belongs, a clustering result is obtained. If the distance between this sample and the k-th class is minimized, then let [symbol] . Assigning all [symbol] samples in this way naturally yields [symbol] that minimizes the sum of the squares of the distances of all samples from the class center.

[symbol]

Keeping fixed and calculating to minimize, that is, updating the center of each class. The objective function [symbol] is a quadratic function of [symbol] , and by making its derivative with respect to [symbol] zero, the objective function can be minimized, that is:

[symbol]

The result of solving for is:
[symbol] ;
is the mean of all the samples in class [symbol] . The samples are reassigned categories and the mean of each class is recalculated, and these two steps are repeated over and over again until one of the following conditions is met:
1) No (or minimum number of) samples are reassigned to different clusters.
2) No (or minimum number of) clustering centers are changed again.
3) The sum of squares of the errors is locally minimized (the change in the value of the objective function is less than a set threshold).

Through the above K-means clustering process, the mean value [symbol] of target class samples and the mean value [symbol] of background class samples can be obtained, and the covariance of target class samples and the covariance [symbol] of background class samples can be obtained by calculation.

[symbol] ;
[symbol] .

Wherein, [symbol] represents the class, [symbol] represents the target class, [symbol] represents the background class, [symbol] is the number of samples belonging to the [symbol] class, [symbol] =( [symbol] is the n-th sample belonging to the k-th class ( ), [symbol] and [symbol] are the linear polarization degree and the polarization angle of the sample point. That is, [symbol] is the mean value of the k-th class sample, and [symbol] is the covariance matrix of the k-th class sample.

S105, initializing a Gaussian mixed model according to the mean value and covariance matrix of the target class pixel points and the mean value and covariance matrix of the background class pixel points, and then performing secondary clustering on the three-dimensional image, and determining a mean value and a covariance matrix of the target class pixel points and a mean value and a covariance matrix of the background class pixel points after secondary clustering;

S105 specifically includes the following steps:

Because the selection of initial class centers will directly affect the clustering results, different initial class centers may get different clustering results. In order to further accurately distinguish the target and background in the image, [symbol] and [symbol] obtained from K-means clustering are adopted as the initial value to replace the Gaussian mixed model (GMM) for clustering to achieve the optimal solution. GMM is generated by K single Gaussian models (K classes). In target detection, every pixel in the image can be described by a hybrid model. Gaussian mixed model refers to the probability distribution model with the following form:
[symbol] ;

Wherein, [symbol] is the weight coefficient, [symbol] , [symbol] ; [symbol] is the Gaussian distribution density, [symbol] ;

[symbol]

In the above formula, [symbol] is the number of classes, and there are target classes and background classes, so [symbol] , and Formula (12) is called the k-th sub-model.

[symbol] and [symbol] is initialized, wherein [symbol] and [symbol] adopt the results obtained after using K-means clustering, [symbol] is the ratio of the number of the data in k-th class to the total number of samples according to the results of K-means clustering. The iteration starts according to the initial value of the parameters, and according to the current model parameters, the responsiveness of sub-model [symbol] to the j-th sample point [symbol] is calculated.

The model parameters of the new iteration are calculated according to the responsiveness [symbol] :

[symbol]

[symbol]

The above iterative steps are repeated until the iterative results converge to a certain small size. According to the final iterative results, the sample mean of target class and the sample mean [symbol] of the background class can be obtained after accurate clustering, and the sample covariance matrix [symbol] of target class and the sample covariance matrix [symbol] of the background class can be obtained by the same calculation according to the formula [symbol] .

S106, constructing a two-dimensional Gaussian probability model based on the mean value and covariance matrix of the target class pixel points after the secondary clustering, and determining a target probability image;

S106 specifically includes the following steps:

The target class mean [symbol] and covariance matrix [symbol] obtained by clustering are adopted to describe the probability distribution of the linear polarization degree and polarization angle of the actual target, a two-dimensional Gaussian probability model is constructed, and the probability that each pixel belongs to the target is calculated. The target probability image P can be obtained by the following process:
1) Gaussian mixed model (GMM) clustering gives the mean [symbol] and covariance matrix of the target class, where [symbol] is the variance of polarization angle, [symbol] is the variance of linear polarization degree, and [symbol] and [symbol] are the covariance between the linear polarization degree and the polarization angle;
[symbol] :
2) A two-dimensional Gaussian probability model is constructed, and the linear polarization degree image and polarization angle image calculated by Stokes vector are normalized and superimposed, that is, each pixel of the superimposed image can be expressed as [symbol] (a two-dimensional vector composed of linear polarization degree and polarization angle). [symbol] is substituted into the two-dimensional Gaussian probability model to calculate the probability that each pixel belongs to the target class, where [symbol] is the probability that the i-th pixel belongs to the target. After normalization, the target probability image [symbol] is obtained.;
[symbol] ;
[symbol] ;

In the above formula, [symbol] , which is the dimension of the Gaussian probability model.

S107, determining a polarization direction orthogonal to a background polarization angle based on the mean value of the polarization angle image in the background class pixel points after the secondary clustering; and thereby determining a target linear polarization component image under a polarization direction orthogonal to the background polarization angle;

S107 specifically includes:
determining a background polarization angle by back-normalizing the mean value of the polarization angle image in the background class pixel points after secondary clustering using the formula [symbol] ;
determining a polarization direction orthogonal to the background polarization angle based on the background polarization angle;
determining a polarization component in a direction orthogonal to the background polarization angle using the formula [symbol] ;
determining a target linear polarization component image in the polarization direction orthogonal to the background polarization angle using the formula [symbol] ;
wherein [symbol] is the background polarization angle, [symbol] is the polarization component in the direction orthogonal to the background polarization angle, [symbol] is the non-polarization light component in [symbol] , is the target linear polarization component image in the polarization direction orthogonal to the background polarization angle, and [symbol] is the mean value of the polarization angle image in the background class pixels after secondary clustering.

The radiation intensity of general scenery can be divided into linearly polarized light component and natural light component [symbol] , which can be expressed by formula and [symbol] and [symbol] can be calculated by Stokes vector.

Wherein, [symbol] ;
[symbol] ;

According to E.L.Malus law, the polarization component [symbol] extracted from the radiation intensity in a specified polarization direction can be divided into linear polarization component [symbol] and non-linear polarization light component [symbol] . The unpolarized light component is half of the natural light component [symbol] , which can be expressed by formula [symbol] , and A is the polarization angle. [symbol] can be obtained from the formula
[symbol] ;
[symbol] ;

Considering that the polarization of the target pixel is consistent, the polarization

direction is [symbol] , the polarization component [symbol] orthogonal to the background polarization angle direction can be obtained by using the formula [symbol] , as shown in the formula [symbol] , thus the linear polarization component of the background pixel can be suppressed.

The non-polarization light component of the polarization component is obtained, and then the linear polarization component of the remaining target pixel of the non-polarization light component is subtracted, as shown in the formula [symbol] .

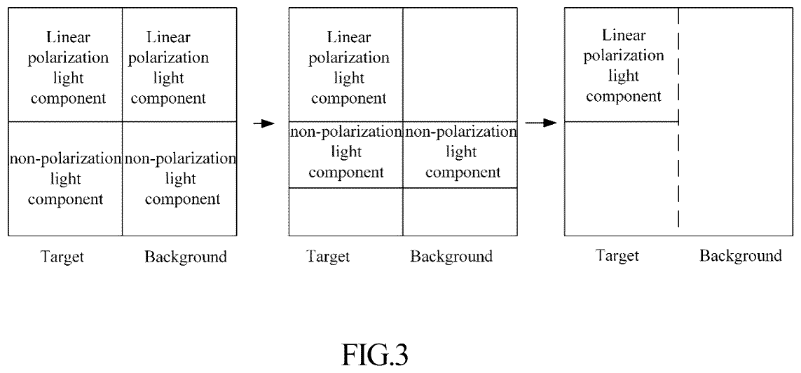

The specific process is shown in FIG. 3. In order to detect the target in the strong stray light background, most of the light intensity information can not be used to identify the target and background, so the polarization component decomposition is adopted to remove the non-linearly polarization light component [symbol] in the polarization component, so that the background information is completely suppressed, and only the target linear polarization light component are retained, which can enhance the drone target.

S108, performing an adaptive contrast entropy top-hat transformation on the light intensity image to determine an output image [symbol] ; that is, the background is suppressed in terms of light intensity.

S108 specifically includes:
applying a weighted local adaptive structural element to the light intensity image and performing an erosion operation;
applying an adaptive structural element to the light intensity image after the erosion operation and performing an expansion operation; and
subtracting the light intensity image after the expansion operation from the light intensity image, and determining the output image after the adaptive contrast entropy top-hat transformation.

The adaptive contrast entropy top-cap transformation uses adaptive structural elements to obtain local features in infrared images, and uses contrast entropy to locally weighted structural elements to adaptively suppress the background information.

Wherein, the adaptive structural element is [symbol] .

[symbol] is an adaptive structural element of [symbol] , corresponding to a filter window [symbol] on the input image [symbol] , and [symbol] is the value of the center point of the filter window, and [symbol] is the value of the filter window except the center point. [symbol] is the mean value of the pixels in the window, [symbol] is the variance of the pixels in the window, and [symbol] is a penalty value. If [symbol] and [symbol] are at the boundary between the target and the background, and [symbol] have different signs, otherwise, they have the same sign. On the other hand, the weight value of the different sign is much smaller than that of the same sign, so the pixels in the flat area will be given more weight, and the smoothing effect will be more obvious, while the pixels on both sides of the boundary will be given less weight, the smoothing effect is weak, which has the effect of maintaining boundaries.

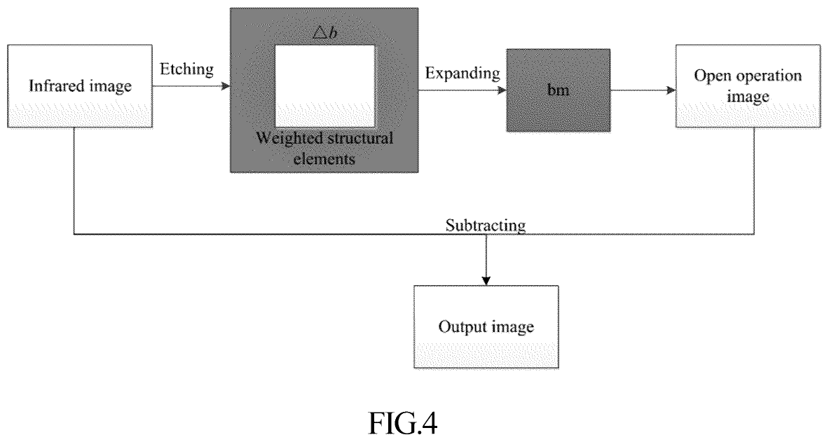

While suppressing the background, the difference information between the target and the surrounding area is adopted to enhance the target. The improved top-cap transformation process is shown in FIG. 4:

For an area with the size of [symbol] , there are altogether [symbol] pixels, in which [symbol] represents the gray value of the central pixel, and each gray level is obtained by histogram statistics of all the pixels in this area. The contrast entropy is defined as follows:
[symbol] ;
where represents the i-th pixel in this area, [symbol] represents the value of [symbol] after low-pass filtering, which can be obtained by filtering the area using a convolution kernel [symbol] . [symbol] represents the probability of the i-th gray level in the probability density function ( [symbol] , and [symbol] is the number of pixels belonging to the i-th gray level).

The weighted local adaptive structural element is adopted to etch I (light intensity image) to get [symbol] ;
[symbol] ;

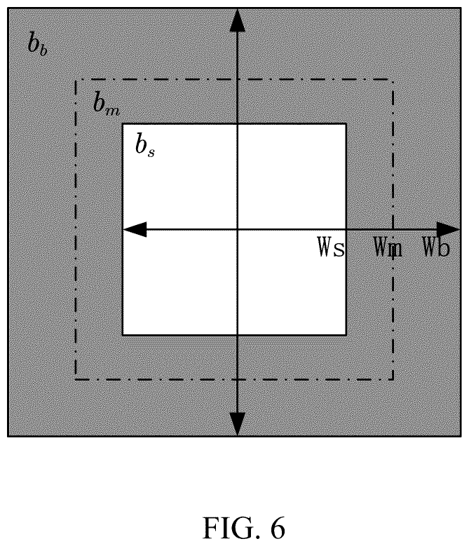

As shown in FIG. 6, three adaptive structural elements with different sizes of [symbol] and the same shape are defined, and the corresponding dimensions are [symbol] , [symbol] is the area obtained by minus, and [symbol] can reflect the difference information between the target area and the background area (in FIG. 6, [symbol] is the dark area, [symbol] is the whole area, is the area in the dotted frame, [symbol] is the white area). By calculating the contrast entropy ( ) in the original image, the [symbol] in the adaptive structural element is weighted, so that the structural element can contain more difference information between the target and the background.
is obtained by expansion operation on [symbol] using adaptive structural elements, that is, [symbol] .

The output of adaptive contrast entropy top-cap transformation [symbol] is obtained by using minus [symbol] , that is, [symbol] .

That is, the formula is adopted to determine the output result of adaptive contrast entropy top-cap transformation.

S109, performing a Laplace pyramid fusion on the output image with the target linear polarization component image to determine a fused image;

Laplace pyramid decomposition can decompose the source image into different layers of the pyramid. Using the decomposed pyramid structure, different fusion operators are adopted to fuse each layer image with different spatial frequencies according to the characteristics of the image. The infrared intensity image transformed by adaptive contrast entropy top-cap and the polarization information image with only the target linear polarization components can be fused together. As a result, the fused image can further suppress the background and improve the contrast between the target and the background.

The process of the Laplace pyramid fusion is as follows:
1) One of the fused images is set to [symbol] , and [symbol] is adopted as the 0 layer after pyramid decomposition, and the low-pass filtering and downsampling of the image are carried out to get the first layer; the image continues to be processed by low-pass filtering and downsampling, and the processed image is the second layer of the pyramid; the Gaussian pyramid of the source image is formed by processing the newly obtained image all the time. It is expressed by a specific formula, where the first layer of the pyramid to be fused is set to [symbol] :

[symbol]

[symbol] ;

Wherein, is the number of layers of the image pyramid to be fused, [symbol] and [symbol] are the columns and rows of the first layer image pyramid formed by the source image decomposition, and [symbol] is the function of low-pass filtering: ;
[symbol] ;
2) The 1-layer in the Gaussian pyramid is interpolated to form an image [symbol] with a size twice as large as itself. The size of [symbol] is equal to the size of the sub-image [symbol] of the lower layer of the pyramid, and the calculation process of image magnification can be expressed by a formula, which is set to Expand, then:
[symbol] ;
[symbol] ;
[symbol] ;

Where:

[symbol]

[symbol]

Each layer sub-image of the Laplace Pyramid is equal to the image of a layer of the Gaussian pyramid formed by the original image minus the sub-image of the layer above it and interpolated twice the size.
3) Each layer of the pyramid formed by the fused two images is compared, and the pixel with a larger gray value of the pixel in each sub-image is selected as the pixel value of the resulting pyramid. It can be assumed that the pyramid level 1 formed by the image A and B to be processed is [symbol] and [symbol] , and the pyramid [symbol] layer formed after processing is [symbol] . The rule of fusion can be defined as:

[symbol] ;

4) After the Laplace pyramid of the two source images are fused to form a new pyramid, the resulting image can only be obtained after the inverse transformation of the pyramid. The specific calculation process is as follows:
[symbol] ;

The infrared intensity image after the adaptive contrast entropy top-cap transformation and the polarization information image [symbol] which only retains the linear polarization component of the target are adopted as the input of image [symbol] and image [symbol] . The fusion output [symbol] of Laplace pyramid is the final fusion image.

S110, determining a binarized image by weighting a membership matrix using the target probability image and clustering the fused image using an intuitionistic fuzzy C-mean clustering algorithm induced by polarization information;

The fuzzy C-means clustering algorithm was first developed by Dunn, and then improved by Bezdek. It obtains the membership degree of each sample point to all class centers by optimizing the objective function, so as to determine the class of the sample point to achieve the purpose of automatically classifying the sample data. Its objective function is defined as follows:
[symbol] ;

In the above formula, [symbol] is the number of clusters, [symbol] is the number of the data, and [symbol] is a fuzzy parameter, which is usually set to 2. [symbol] and [symbol] represent the k-th data point and the i-th clustering center, respectively. [symbol] represents the membership degree that [symbol] belongs to [symbol] , as defined as follows: ;
[symbol] ;

The local minimum of the objective function is obtained by an iterative operation through Lagrange multiplier method as follows:
[symbol] ;
[symbol] ;

In order to further improve the effect of FCM clustering, Vlaschos and Sergiadis introduce intuitionistic fuzzy set theory to represent images in the form of IFS. [symbol] is set to be an image with [symbol] pixels, [symbol] is the gray level of the k-th pixel, and the IFS form of image [symbol] is as follows:
[symbol] ;

[symbol] represent the membership degree and non-membership degree of pixel [symbol] respectively. The calculation process of membership degree and non-membership degree is as follows:
[symbol] ;
[symbol] ;

[symbol] and [symbol] represent the maximum and minimum gray levels of image [symbol] respectively, where [symbol] is a constant that controls the ratio between membership degree and hesitation degree. At this point, the image is transferred to the intuitionistic fuzzy domain, and the objective function of the intuitionistic fuzzy C-means clustering algorithm can be expressed as follows:
[symbol] ;
[symbol] ;

Wherein, [symbol] is expressed in the form of IFSs as [symbol] . The clustering center [symbol] can be expressed as [symbol] . The Euclidean intuitionistic fuzzy distance [symbol] from [symbol] to [symbol] is defined as follows:
[symbol] ;

Like FCM, the objective function can be solved iteratively based on Lagrange multiplier method.

Firstly, the Laplace pyramid image fusion result [symbol] of the target linear polarization component image and the infrared image transformed by adaptive contrast entropy top-cap are adopted as the input image of clustering. Using the target mean [symbol] and covariance matrix obtained by GMM clustering, a two-dimensional Gaussian probability model is constructed to determine the target probability image [symbol] , [symbol] is the value of the k-th pixel in the target probability image, and the probability weight coefficient [symbol] is introduced into the objective function of intuitionistic fuzzy C-means clustering, as follows:

[symbol] ;

[symbol] is the probability that the k-th pixel belongs to the target, different i values represent different classes, and [symbol] takes different index values. In this method, i=1 represents the background class, i=2 represents the target area, with values, [symbol] ;

Final objective function:
[symbol] ;

Constraints:
[symbol] ;

Constructing the Lagrange objective function:
[symbol] ;

In the above formula, [symbol] is a Lagrangian multiplier. In order to obtain the optimal solution of the Lagrangian objective function, the partial derivatives of [symbol] and [symbol] are calculated respectively, so that the derivative result is equal to zero:
[symbol] ;
[symbol] ;
[symbol] ;
[symbol] ;

By solving the above equation synchronously, the membership degree and clustering center can be obtained:
[symbol] ;
[symbol] ;
[symbol] ;
[symbol] ;

The clustering process is as follows:
1) using the mean and covariance of the target class to construct a two-dimensional Gaussian probability model and calculating the target probability image P;

2) setting the number of clusters, fuzzy parameter m=2, iterative threshold, initializing membership matrix U and clustering center randomly;

3) updating the membership matrix U and the clustering center, and setting t=1.

4) when [symbol] , stopping the iteration; otherwise returning to the second step, [symbol] ;

5) when the clustering meets the stop condition, setting the pixel [symbol] corresponding to the membership degree of the target class is greater than that of the background class (that is, [symbol] ) to 255, otherwise setting the same to 0, and outputting the binarized image;

The clustering result is output as a binarized image [symbol] , and the white area is the drone target to be detected.

S111, determining a target based on the binarized image; wherein the target is a drone.

The present disclosure adopts infrared polarization image, based on the idea of processing the polarization image to decompose the invalid intensity components and extract the most effective polarization information among them, obtains the background polarization angle through GMM clustering, eliminates the background linear polarization components by extracting the target line polarization components orthogonal to the direction of the background polarization angle and basically retains the target linear polarization components (which embody the target detail contour), so as to achieve the effect of polarization dimensional suppression of the background; the top-hat transformation is a morphological method capable of background weakening for infrared images, and now there are a number of improved top-hat transformation algorithms. The present disclosure proposes an improved adaptive contrast entropy top-hat transformation to achieve background suppression in infrared images; the present disclosure generates the target linear polarization component image orthogonal to the polarization angle of the background by calculating, so as to achieve background suppression in the dimension of polarization information; and through the adaptive contrast entropy top-hat transformation of the infrared image, the background suppression in the dimension of intensity information is achieved. The background suppression effect of [symbol] is achieved by fusing the infrared image with suppressed background and the polarization image.

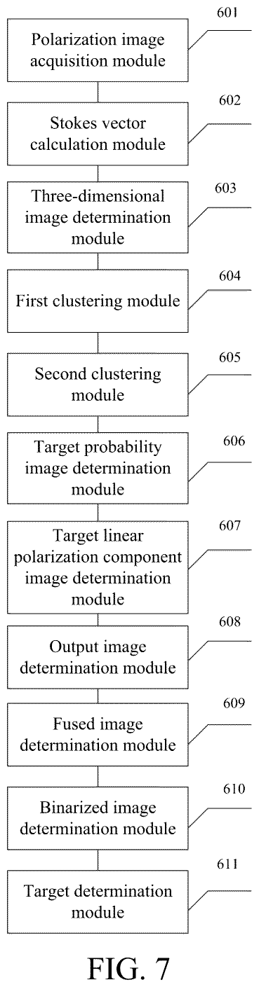

FIG. 7 shows a schematic diagram of the structure of a drone detection system based on infrared polarization provided by the present disclosure, as shown in FIG. 7, the drone detection system based on infrared polarization provided by the present disclosure includes:
a polarization image acquisition module 601, for acquiring polarization images at three different polarization angles in a target scene;
a Stokes vector calculation module 602, for calculating a Stokes vector based on the polarization images at three different polarization angles; wherein the Stokes vector comprises: a light intensity image, a difference between a horizontal linear polarization component and a vertical linear polarization component, and a difference between a 45° linear polarization component and a 135° linear polarization component;
a three-dimensional image determination module 603, for determining a three-dimensional image by normalizing a linear polarization degree image and a polarization angle image determined according to the Stokes vector separately, and then superimposing the normalized linear polarization degree image and the normalized polarization angle image;
a first clustering module 604, for performing coarse clustering on the three-dimensional image using a K-means clustering method to classify pixel points of the three-dimensional image into target class pixel points and background class pixel points; and calculating a mean value and a covariance matrix of the target class pixel points and a mean value and a covariance matrix of the background class pixel points, respectively;
a second clustering module 605, for initializing a Gaussian mixture model according to the mean value and covariance matrix of the target class pixel points and the mean value and covariance matrix of the background class pixel points, and then performing secondary clustering on the three-dimensional image, and determining a mean value and a covariance matrix of the target class pixel points and a mean value and a covariance matrix of the background class pixel points after secondary clustering;
a target probability image determination module 606, for constructing a two-dimensional Gaussian probability model based on the mean value and covariance matrix of the target class pixel points after the secondary clustering, and determining a target probability image;
a target linear polarization component image determination module 607, for determining a polarization direction orthogonal to a background polarization angle based on the mean value of the polarization angle image in the background class pixel points after the secondary clustering; and thereby determining a target linear polarization component image under a polarization direction orthogonal to the background polarization angle;
an output image determination module 608, for performing an adaptive contrast entropy top-hat transformation on the light intensity image to determine an output image;
a fused image determination module 609, for performing a Laplace pyramid fusion on the output image with the target linear polarization component image to determine a fused image;
a binarized image determination module 610, for determining a binarized image by weighting a membership matrix using the target probability image and clustering the fused image using an intuitionistic fuzzy C-mean clustering algorithm induced by polarization information; and
a target determination module 611, for determining a target based on the binarized image; wherein the target is a drone.

The Stokes vector calculation module 602 specifically includes:
a light intensity image determination unit for determining the light intensity image using the formula [symbol] ;
a difference between horizontal linear polarization component and vertical linear polarization component determination unit for determining the difference between the horizontal linear polarization component and the vertical linear polarization component using the formula [symbol] ;
a difference between 45° linear polarization component and 135° linear polarization component determination unit for determining the difference between the 45° linear polarization component and the 135° linear polarization component using the formula [symbol] ;

wherein, [symbol] is the light intensity image, [symbol] is the difference between the horizontal linear polarization component and the vertical linear polarization component, [symbol] is the difference between the 45° linear polarization component and the 135° linear polarization component, and represents a polarization image when the polarizer is rotated at an angle of, [symbol] .

The target linear polarization component image determination module 607 specifically includes:
a background polarization angle determination unit for determining a background polarization angle by back-normalizing the mean value of the polarization angle image in the background class pixel points after secondary clustering using the formula [symbol] ;
a polarization direction orthogonal to the background polarization angle determination unit for determining a polarization direction orthogonal to the background polarization angle based on the background polarization angle;
a polarization component determination unit for determining a polarization component in a direction orthogonal to the background polarization angle using the formula [symbol] ;

a target linear polarization component image determination unit for determining a target linear polarization component image in the polarization direction orthogonal to the background polarization angle using the formula [symbol] ;
wherein [symbol] is the background polarization angle, [symbol] is the polarization component in the direction orthogonal to the background polarization angle, [symbol] is the non-polarization light component in [symbol] , is the target linear polarization component image in the polarization direction orthogonal to the background polarization angle, and [symbol] is the mean value of the polarization angle image in the background class pixels after secondary clustering.

The output image determination module 608 specifically includes:
an erosion operation unit for applying a weighted local adaptive structural element to the light intensity image and performing an erosion operation;
an expansion operation unit for applying an adaptive structural element to the light intensity image after the erosion operation and performing an expansion operation; and
an output image determination unit for subtracting the light intensity image after the expansion operation from the light intensity image, and determining the output image after the adaptive contrast entropy top-hat transformation.

Various embodiments in the present specification are described in a progressive manner, and the emphasizing description of each embodiment is different from the other embodiments. The same and similar parts of various embodiments can be referred to for each other. For the system disclosed in the embodiments, since the apparatus corresponds to the method disclosed in the embodiments, the description is simplified, and reference may be made to the method part for description.

In this paper, a specific embodiment is applied to explain the principle and implementation mode of the disclosure, and the description of the above embodiment is only used to help understand the method and the core idea of the disclosure; at the same time, for the general technicians in the field, according to the idea of the disclosure, there will be changes in the specific implementation mode and application scope. To sum up, the contents of this specification should not be understood as restrictions on the present disclosure.

What is claimed is:

1. A drone detection method based on infrared polarization, comprising:
acquiring polarization images at three different polarization angles in a target scene;
calculating a Stokes vector based on the polarization images at three different polarization angles; wherein the Stokes vector comprises: a light intensity image, a difference between a horizontal linear polarization component and a vertical linear polarization component, and a difference between a 45° linear polarization component and a 135° linear polarization component;
normalizing a linear polarization degree image and a polarization angle image determined according to the Stokes vector separately, and then superimposing the normalized linear polarization degree image and the normalized polarization angle image to determine a three-dimensional image;
performing coarse clustering on the three-dimensional image using a K-means clustering method to classify pixel points of the three-dimensional image into target class pixel points and background class pixel points; and calculating a mean value and a covariance matrix of the target class pixel points and a mean value and a covariance matrix of the background class pixel points, respectively;
initializing a Gaussian mixed model according to the mean value and covariance matrix of the target class pixel points and the mean value and covariance matrix of the background class pixel points, and then performing secondary clustering on the three-dimensional image, and determining a mean value and a covariance matrix of the target class pixel points and a mean value and a covariance matrix of the background class pixel points after the secondary clustering;
constructing a two-dimensional Gaussian probability model based on the mean value and covariance matrix of the target class pixel points after the secondary clustering, and determining a target probability image;
determining a polarization direction orthogonal to a background polarization angle based on the mean value of the polarization angle image in the background class pixel points after the secondary clustering; and thereby determining a target linear polarization component image under the polarization direction orthogonal to the background polarization angle;
performing an adaptive contrast entropy top-hat transformation on the light intensity image to determine an output image;
performing a Laplace pyramid fusion on the output image with the target linear polarization component image to determine a fused image;
determining a binarized image by weighting a membership matrix using the target probability image and clustering the fused image using an intuitionistic fuzzy C-mean clustering algorithm induced by polarization information; and
determining a target based on the binarized image; wherein the target is a drone.

2. The drone detection method based on infrared polarization of claim 1, wherein the step of calculating a Stokes vector based on the polarization images at three different polarization angles specifically comprises:
determining the light intensity image using the formula;
determining the difference between the horizontal linear polarization component and the vertical linear polarization component using the formula;
determining the difference between the 45° linear polarization component and the 135° linear polarization component using the formula;
wherein, is the light intensity image, is the difference between the horizontal linear polarization component and the vertical linear polarization component, is the difference between the 45° linear polarization component and the 135° linear polarization component, and represents a polarization image when a polarizer is rotated at an angle of.

3. The drone detection method based on infrared polarization of claim 2, wherein the step of determining a polarization direction orthogonal to a background polarization angle based on the mean value of the polarization angle image in the background class pixel points after the secondary clustering; and thereby determining a target linear polarization component image under the polarization direction orthogonal to the background polarization angle specifically comprises:
determining a background polarization angle by back-normalizing the mean value of the polarization angle image in the background class pixel points after secondary clustering using the formula;
determining a polarization direction orthogonal to the background polarization angle based on the background polarization angle;
determining a polarization component in a direction orthogonal to the background polarization angle using the formula;
determining a target linear polarization component image in the polarization direction orthogonal to the background polarization angle using the formula;
wherein is the background polarization angle, is the polarization component in the direction orthogonal to the background polarization angle, is the non-polarization light component in, is the target linear polarization component image in the polarization direction orthogonal to the background polarization angle, and is the mean value of the polarization angle image in the background class pixels after secondary clustering.

4. The drone detection method based on infrared polarization of claim 1, wherein the step of performing an adaptive contrast entropy top-hat transformation on the light intensity image to determine an output image, specifically comprises:
applying a weighted local adaptive structural element to the light intensity image and performing an erosion operation;
applying an adaptive structural element to the light intensity image after the erosion operation and performing an expansion operation; and
subtracting the light intensity image after the expansion operation from the light intensity image, and determining the output image after the adaptive contrast entropy top-hat transformation.

5. A drone detection system based on infrared polarization, comprising:
a polarization image acquisition module for acquiring polarization images at three different polarization angles in a target scene;
a Stokes vector calculation module for calculating a Stokes vector based on the polarization images at three different polarization angles; wherein the Stokes vector comprises:
a light intensity image, a difference between a horizontal linear polarization component and a vertical linear polarization component, and a difference between a 45° linear polarization component and a 135° linear polarization component;
a three-dimensional image determination module for determining a three-dimensional image by normalizing a linear polarization degree image and a polarization angle image determined according to the Stokes vector separately, and then superimposing the normalized linear polarization degree image and the normalized polarization angle image;
a first clustering module for performing coarse clustering on the three-dimensional image using a K-means clustering method to classify pixel points of the three-dimensional image into target class pixel points and background class pixel points; and calculating a mean value and a covariance matrix of the target class pixel points and a mean value and a covariance matrix of the background class pixel points, respectively;
a second clustering module for initializing a Gaussian mixture model according to the mean value and covariance matrix of the target class pixel points and the mean value and covariance matrix of the background class pixel points, and then performing secondary clustering on the three-dimensional image, and determining a mean value and a covariance matrix of the target class pixel points and a mean value and a covariance matrix of the background class pixel points after secondary clustering;
a target probability image determination module for constructing a two-dimensional Gaussian probability model based on the mean value and covariance matrix of the target class pixel points after the secondary clustering, and determining a target probability image;
a target linear polarization component image determination module for determining a polarization direction orthogonal to a background polarization angle based on the mean value of the polarization angle image in the background class pixel points after the secondary clustering; and thereby determining a target linear polarization component image under a polarization direction orthogonal to the background polarization angle;
an output image determination module for performing an adaptive contrast entropy top-hat transformation on the light intensity image to determine an output image;
a fused image determination module for performing a Laplace pyramid fusion on the output image with the target linear polarization component image to determine a fused image;
a binarized image determination module for determining a binarized image by weighting a membership matrix using the target probability image and clustering the fused image using an intuitionistic fuzzy C-mean clustering algorithm induced by polarization information; and
a target determination module for determining a target based on the binarized image; wherein the target is a drone.

6. The drone detection system based on infrared polarization of claim 5, wherein the Stokes vector calculation module specifically comprises:
a light intensity image determination unit for determining the light intensity image using the formula [symbol] ;
a difference between horizontal linear polarization component and vertical linear polarization component determination unit for determining the difference between the horizontal linear polarization component and the vertical linear polarization component using the formula [symbol] ;
a difference between 45° linear polarization component and 135° linear polarization component determination unit for determining the difference between the 45° linear polarization component and the 135° linear polarization component using the formula [symbol] ;
wherein, [symbol] is the light intensity image, [symbol] is the difference between the horizontal linear polarization component and the vertical linear polarization component, [symbol] is the difference between the 45° linear polarization component and the 135° linear polarization component, and represents a polarization image when the polarizer is rotated at an angle of [symbol] .

7. The drone detection system based on infrared polarization of claim 6, wherein the target linear polarization component image determination module specifically comprises:
a background polarization angle determination unit for determining a background polarization angle by back-normalizing the mean value of the polarization angle image in the background class pixel points after secondary clustering using the formula [symbol] ;
a polarization direction orthogonal to the background polarization angle determination unit for determining a polarization direction orthogonal to the background polarization angle based on the background polarization angle;
a polarization component determination unit for determining a polarization component in a direction orthogonal to the background polarization angle using the formula [symbol] ;
a target linear polarization component image determination unit for determining a target linear polarization component image in the polarization direction orthogonal to the background polarization angle using the formula [symbol] ;
wherein is the background polarization angle, [symbol] is the polarization component in the direction orthogonal to the background polarization angle, [symbol] is the non-polarization light component in [symbol] , is the target linear polarization component image in the polarization direction orthogonal to the background polarization angle, and [symbol] is the mean value of the polarization angle image in the background class pixels after secondary clustering.

8. The drone detection system based on infrared polarization of claim 5, wherein the output image determination module specifically comprises:
an erosion operation unit for applying a weighted local adaptive structural element to the light intensity image and performing an erosion operation;
an expansion operation unit for applying an adaptive structural element to the light intensity image after the erosion operation and performing an expansion operation; and
an output image determination unit for subtracting the light intensity image after the expansion operation from the light intensity image, and determining the output image after the adaptive contrast entropy top-hat transformation.
